(19) United States
(12) Patent Application Publication
(10) Pub. No.: US 2008/0313041 A1
(43) Pub. Date: Dec. 18, 2008

(54) MULTI LEVEL MARKETING FOR BUSINESSES AND CONSUMERS

(76) Inventor: Pinny RABENOU, Beit Zait (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/137,597

(22) Filed: Jun. 12, 2008

Related U.S. Application Data
(60) Provisional application No. 60/943,555, filed on Jun. 13, 2007.

(51) Int. Cl. G06Q 30/00

(52) U.S. Cl. 705/14

(57) ABSTRACT

A novel marketing system and method wherein consumers and businesses join a network which increases commercial activity in a synergetic manner, providing profits and monetary rewards to consumer members and participant businesses. Participant businesses use the network as a platform for self advertising for which expenses are paid only after achieving a sale. The customers in the network are associated with a club, are placed in a multilevel structure reflecting recruiting order, and get rewards which are associated to actual sales in the whole network for which they are directly or indirectly responsible. A fundamental aspect of the multilevel marketing network of present invention is the fact that it is expanding continuously by recruiting both new consumers and new participating businesses.

### CROSS REFERENCE TO RELATED APPLICATIONS

This application claims the benefit from US provisional application 60/943,555 filed 13 Jun. 2007 by the present inventor.

### FIELD OF THE INVENTION

The present invention relates to the field of marketing and advertisement, more particularly to the field of consumer clubs which promote sales and distribution of products and services by discount sales to the club members and by providing advertisement to businesses. The present invention also relates to multilevel marketing, in which a person recruits other persons to a marketing campaign and gets benefits from their outcome down an hierarchy of recruiters.

### BACKGROUND OF THE INVENTION

Multi level marketing (MLM) networks are known in the art, some of them are based on tangible transfer of products along a chain of distributors and others promote the increase of a customer base for a specific product.

Multi level marketing businesses function by recruiting sales people (also called distributors, independent business owners, franchise owners, sales consultants, etc.) to sell a product and offer additional sales commissions based on the sales of people recruited into their sale down line.

This arrangement is similar to franchise arrangements where royalties are paid from the sales of individual franchise operations to the franchisor as well as to an area or a region manager, but in some MLM programs, there can be seven or more levels of people receiving royalties from one person's sales.

Some MLM methods are documented.

U.S. application No. 2007/0265913 to Brownlee describes a method of recruiting individuals from a target demographic to become members of a multi-level marketing system wherein the individuals may be required to register with the multi-level marketing system in order to purchase an exclusive product.

U.S. application No. 2007/0288395 to Maggio describes a method in which a first entity can recruit a second entity to collaborate in a promotional activity, such as marketing a product or spreading commercial information via a multi-level marketing program. If the first entity achieves success, the second entity can benefit.

U.S. application No. 2006/0190325 to Tarsh describes an internet-enabled network marketing method having a new member introducer identification in which the new member recommends on a product and the introducer is rewarded a commission based on the recommended product purchase by his “circle of friends”.

U.S. application No. 2006/0235749 to Moe describes a multi-level marketing system uniting businesses providing an exclusive product and individuals as a team to help each other to earn monetary rewards based on sales and profit sharing of the exclusive product.

All the above mentioned MLM networks promote the purchase of a limited kind of products or services provided by a single vendor.

### SUMMARY OF THE INVENTION

The present invention is a novel marketing system and method wherein consumers and businesses join a network which increases commercial activity in a synergetic manner, thus causing its consumer members and participant businesses to profit monetary rewards.

A fundamental aspect of the multilevel marketing network of present invention is the fact that it is expanding continuously by recruiting both new consumers and new participating businesses.

The participant businesses use the network as a platform for self advertising for which expenses are paid only after achieving a sale.

As for the customers in the network, they are associated with a club and they are organized in a multilevel structure which follows recruiting order. The customer members may get from the club rewards which are associated to actual sales, or are associated to the actual discounts received by customers by the businesses in the network, wherein the members are directly or indirectly responsible for the sales or for the discounts.

It is provided, for the first time, a multilevel marketing network system for businesses and consumers. The system comprises:
(a) A club which arranges membership of the consumers and participation of businesses in the multilevel marketing network and coordinates the multilevel marketing network operation.
(b) Participant businesses which provides goods or services.
(c) A plurality of club members in the club which includes club members which purchase in the participant businesses. The plurality of club members in the club are organized in a recruiting down-line hierarchy.
   The participant businesses offer a discount to the plurality of club members and each club member is rewarded in accordance to purchases done in the participant businesses by club members on his recruiting down-line.

In some embodiments, the club sells club money to the club members.

In some embodiments, the nominal value of the club money is equal or more than its cost to club members.

In some embodiments, revenues of the club include redemption of selling the club money.

In some embodiments, club members persuade businesses to become a participant businesses in the multilevel marketing network, and may get an appropriate reward.

In some embodiments, participant businesses commit to accept club money as a partial payment for goods or services. The club members or other holders of club money pay the partial payment with club money.

In some embodiments, the discount offered by participant businesses to the plurality of club members is implemented by the partial payment with the club money.

In some embodiments, participant business enjoys a fee free trial period when joining the multilevel marketing network.

In some embodiments, participant business bears a once made payment for participating in the multilevel marketing network after termination of the trial period.

In some embodiments, the club sells club money to a non-club member consumer.

In some embodiments, a club member may sell, and even is encouraged to sell, club money to a non-club member consumer.

In some embodiments, the club pays a reward to each club member in accordance to total actual sales in the multilevel marketing network which were affected by him.

In some embodiments, the reward includes a monetary reward.

In some embodiments, the monetary reward is for a payment selected from the group consisting of a payment for buying club money, a payment for persuading new business to join the multilevel marketing system and a recruiting commission.

In some embodiments, the recruiting commission includes a monthly payment to the each club member in accordance to the monthly total amount of the club money which was purchased by club members in the recruiting down-line of the each member.

In some embodiments, allocation of the monetary reward to the club members is implemented by using an application software running on a processing unit of a computer system. The computer system may further includes an operating system, a system memory, a media storage device, input and output interfaces and an internet network adaptor.

It is provided, for the first time, a method for multilevel marketing network which combines consumers and businesses. The method comprises the steps of:
(a) Establishing a multilevel marketing network which includes a club which arranges membership of consumers and participation of businesses in the multilevel marketing network, participant businesses which offer discount to club members, club members which purchases in the participant businesses. The club members are organized in a recruiting down-line hierarchy.
(b) Advertising the participant businesses in a page of a website of the club.
(c) Buying club money by the club members from the club,
(d) Making purchases at the participant businesses by club members, and paying partially with the bought club money.
(e) Recruiting by club members additional customers as new club members, wherein the new club member is associated to the recruiter down-line.

In some embodiments, the method further includes the step of persuading by club members additional businesses to join the multilevel marketing network.

In some embodiments, the advertising includes an announcement of the discount offered by the participant business to the club members.

In some embodiments, the method further includes the steps of:
(g) Paying a reward to each club member in accordance to total actual sales in the multilevel marketing network which were effected by the each club member.
(h) Rewarding club member persuaders of additional businesses by the club.
(i) Selling club money to non club members.

In some embodiments, the selling of the club money to a non-club member is carried out by the club.

In some embodiments, the selling of the club money to a non- club member is carried out by a club member.

In some embodiments, the allocation of the monetary reward is implemented by using an application software running on a processing unit of a computer system. The computer system may further includes an operating system, a system memory, a media storage device, input and output interfaces and an internet network adaptor.

In some embodiments, the rewarding of the club member persuader of an additional business is in accordance with all sales of the business to all club members, or the size of the business in terms of annual revenues, or the number of stores of the business.

Other objects and goals of the present invention will become apparent upon reading the following description in conjunction with the following figures.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 shows the elements of the multilevel marketing system of the present invention.

FIG. 2 shows a flow chart of the multilevel marketing method of the present invention.

FIG. 3 shows a down-line hierarchy of recruited members of the multilevel marketing system of the present invention.

FIG. 4 shows a computer system of the multilevel marketing system of the present invention.

### DETAILED DESCRIPTION OF PREFERRED EMBODIMENTS

The present embodiments herein are not intended to be exhaustive and to limit in any way the scope of the invention; rather they are used as examples for the clarification of the invention and for enabling of other skilled in the art to utilize its teaching.

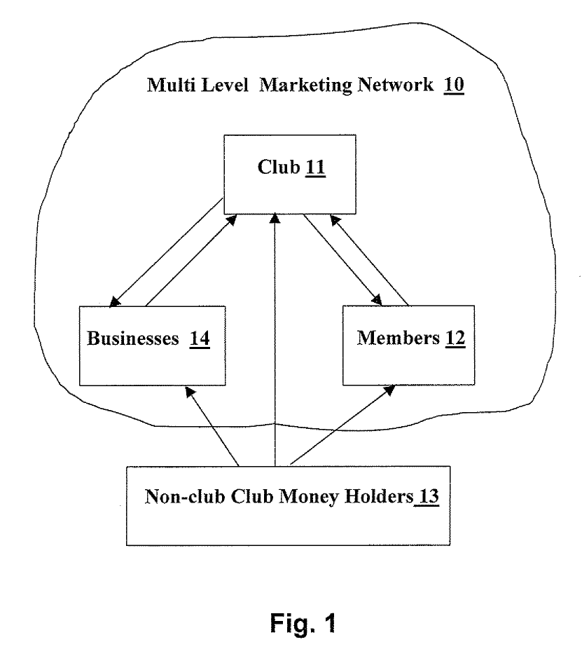

FIG. 1 shows essential elements of a multi-layer marketing (MLM) network 10, of the present invention, which include a club 11, club members 12, non-member club money holders (CMH) 13 and participant businesses 14. The arrows show possible direction of real money flow between the elements in the network.

Club 11 is an entity which firstly, establishes MLM network 10 by recruiting first members and first participant businesses to join MLM network 10 and secondly, it manages and controls MLM network to operations as will be detailed below.

Activities of club 11 include: selling of club money to club members 12 and to non-member CMH 13, arranging the membership of new joining club members, handling an account for each of them and rewarding them in real money, enlisting new participant businesses to MLM network and exposing them in a club 11 website. The term “club money” refers hereinafter to any type of partial payment except real money which is accepted by a participant business 14 in exchange to its goods or services.

Club money can be in a form of notes, “fake” money, group checks that cannot be cashed, and credit cards enabling payment in participant business only, and only for paying the discount given in club money.

Club members 12 are registered individuals, groups or organizations which are committed to purchase preferentially in participant businesses 14 and manifest that commitment by buying club money from club.

Non-member club money holders 13 include customers which possesses club money and are not club members 12.

Participating business 14 are businesses which offer an exclusive discount to club members 12 and to non-member CMH 13, through a commitment to accept an agreed percentage (e.g. 20%) of the bill on a purchase in club money according to the club money nominal value.

In some embodiments, the agreed percentage is between 1% and 80%.

In some embodiments, the business agree to get all the money in club money. Such businesses may make their living from a source different from the customers, and are attracted to the club by the free advertisement provided by the club.

In some embodiments, the club money becomes obsolete once it have been accepted by a participating business.

In some embodiments, the businesses transfer the club money they accept to the club and receive in return a minor portion of the nominal value in real money.

In some embodiments, that minor portion of the club money is in the range between 1% and 10%, as agreed upon between the club and a participating business regarding certain time duration. For example, suppose that the club would like to advertise a discount of 15% in a certain business for Christmas sales time, while the certain business can allow only a 10% discount. The club may agree to bridge the 5% gap, and may advertise a 15% discount at that certain business. The club members or non-club CMHs shop at 15% discount, paying the discount with club money. Later on , the business returns the club money to the club, getting the difference 5% in real money, so that the business real discount happens to be only 10%, as agreed upon.

The MLM network of the present invention promotes commercial activity as a whole by satisfying interests of both participant businesses and consumer members in several aspects.

Referring to the participant businesses, the club may enlist them as participating businesses for free or for a monthly fee.

In some embodiments, a business joining the MLM network may enjoy a trial period which is free of any fee. During the trial period the business is presented to consumers in the club's website, getting a free advertising media for its service and products. Upon termination of the trial period, the business may continue an unlimited participation in the network for a single payment.

The website page of the participant business within a club website may include the level of club money share accepted by the business.

In some embodiments, the website page of the participant business within a club website may allow customers to post their satisfaction with the services and products of the business.

In some embodiments, there may be a ranking system for the business, reflecting the customer satisfaction level. Naturally, a business that gives a higher discount and which is ranked higher by previous customers will be more attractive to club members. Moreover, club members have incentives for getting discount via a partial payment with club money. Hence, participant businesses enjoy a motivated and loyal customer base. Note that customer attraction to a participant business is obtained merely by the business agreement to accept club money, without any need of the business to invest money in advertisement before an actual sale. The discount is actually a post sale payment, paid only for a successful advertisement.

Referring to the club members, they enjoy the discount which is offered by the participating businesses, and are also motivated to enhance use of club money as it increases a reward paid to them by the club, as explained below.

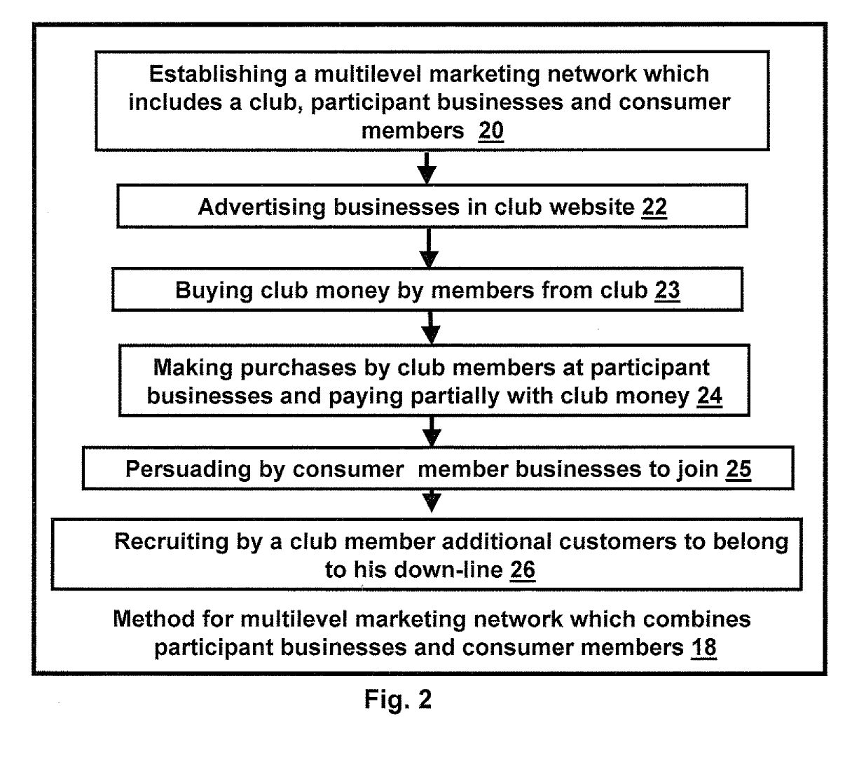

The flowchart of FIG. 2 presents a method 18 of MLM network, supporting the combined benefits for both participant business and club members is explained.

Once club 11 is established 20 and its administration is set up, it begins to enlist as much as possible participant businesses 14, with a diversity of products and services. Businesses are allowed to participate in MLM network 10 on a basis of no participating fee for a trial period and after its termination, for a single payment.

The participating businesses are advertised 22 in the club website.

Participant businesses 14 are committed to accept an agreed percentage (e.g. 25%) of their bill to club money holders in club money. As will become apparent below, only a fraction of the payment with club money constitutes a real discount.

In some embodiments, this real discount may be at least as high as the announced discount level of the participant business, as applicable for non-club members.

In some embodiments, the discount to club members is offered on top of discounts given to non-members.

After at least a first business agrees to participate in MLM network 10, it is possible to recruit consumers as club members 12 of the MLM network 10. The recruitment is enhanced by the exclusive reductions offered to club money holders.

Recruiting consumers as club members can be accomplished by any way of communicating with club 11, e.g. by a letter, Fax, e-mail or by a telephone call.

A club member may be qualified to persuade 25 a business outside MLM network 10 to be enlisted as a participant business, and is rewarded for each persuaded business which actually joins the club 11.

In some embodiments, the customer qualification to enlist new business is obtained by participation of a free seminar suggested to members by the club 11.

In some embodiments, the reward size may be in accordance with the size of the persuaded business in terms like annual revenues, number of locations, etc.

In some embodiments, the reward size may be in accordance with applicable monthly payment or with a single payment, when applicable.

The persuading 25 can be accomplished by any way of recommending e.g. by a door to door meeting, but preferably by a telephone call made to the business.

By enlisting new participant businesses the diversity of products for which a discount is offered to club-members 12 and non club member CMH 13 increases, attracting more customers to club 11, which in turn encourages further new businesses to participate in MLM network 10 and vice versa. Thus, MLM network 10 may be dynamically expanding.

As a member recruits a customer to the club 11 as a registered member, the recruiter identification is saved in the club records for later use. The joining member gets a club account, pays a deposit and gets an agreed amount of club money.

In some embodiments, the deposit is fully refundable upon leaving the club.

Usually, but not necessarily, the nominal value of club money obtained exceeds the value of the money paid for, e.g. a club member gets $240 of club money for a price of $200.

In some embodiments the club members pays between 20% and 100% of the club money nominal value.

In some embodiments the club members pays between 30% and 70% of the club money nominal value.

For exemplary 80% payment, there is a nominal increase of 25% in the consuming power of club member 12 when shopping at participant businesses 14. Additional and non limited amount of club money can be bought 23 by club member 12 at any stage. Moreover, the club member may sell club money to non club member CMH 13 at an agreed upon price, in between the amount he have paid and the nominal value, and thus may make some profit from such a mediation. The club money holders, members and non members, are making purchases 24 paying the discount part with the club money.

Regarding the real discount, using the exemplary 80% payment for the club money, a club money holder pays an exemplary 25% of a bill in club money, and the real discount on the transaction is 20% of 25%, which is 5%. In some embodiments, the club may prohibit the business to give more than a 5% discount to non-club customer which pay real money, such that the club members are, at least, not in a worse position than non-club customers.

The money which was paid for purchasing club money is part of club 11 revenue. The revenue, subtracting expenditures, is partially rewarded back to club members 12 in accordance to their contribution to club 11 income.

A criterion to such a contribution can be the total amount of club money purchased from club 11 for which club member 12 is directly and indirectly responsible. Direct responsibility is by purchase of club money, even if later sold to non-club customers. Indirect responsibility may include purchases by club members in the member down-line.

Different schemes may evaluate this contribution and are included in the present invention; the following scheme for rewarding club members 12 is a demonstrative example only which does not limit in any way the scope of the present invention.

Upon joining club 1 1 each club member 12 opens a “profit center” in its account, accumulating points awarded for his activity in MLM network 10, and allowing their consumption.

In an example, a joining member gets 250 points for joining club 11, a club member gets 100 points for purchasing $150 of club money, and a club member enlisting a participant business to MLM network 10 gets 50 points. These points may be rewarded with real money.

In some embodiments, each club member gets a monthly payment which is proportional to the amount of points which are possessed in his account in that month, e.g. a sum in U.S dollars which equals to 1-10% of accumulated points.

Besides, each club member gets a commission of a certain percent e.g. 10% of the total number of point possessed by club member which are along his recruiters down-line. Thus, a member is motivated to recruit 26 a consumer as a club market which resides in his down line.

In some embodiments, the recruiter commission points given to a member in his down-line decreases with the distance between the two members. However, as the number of recruited members may increase with the distance, the benefits obtained due to purchases of distant recruits may increase with time. For example, the recruiter may receive 0.20 points per each point a “child” recruited member gets, but only 0.15 points per each point a “grandchild” recruited members gets.

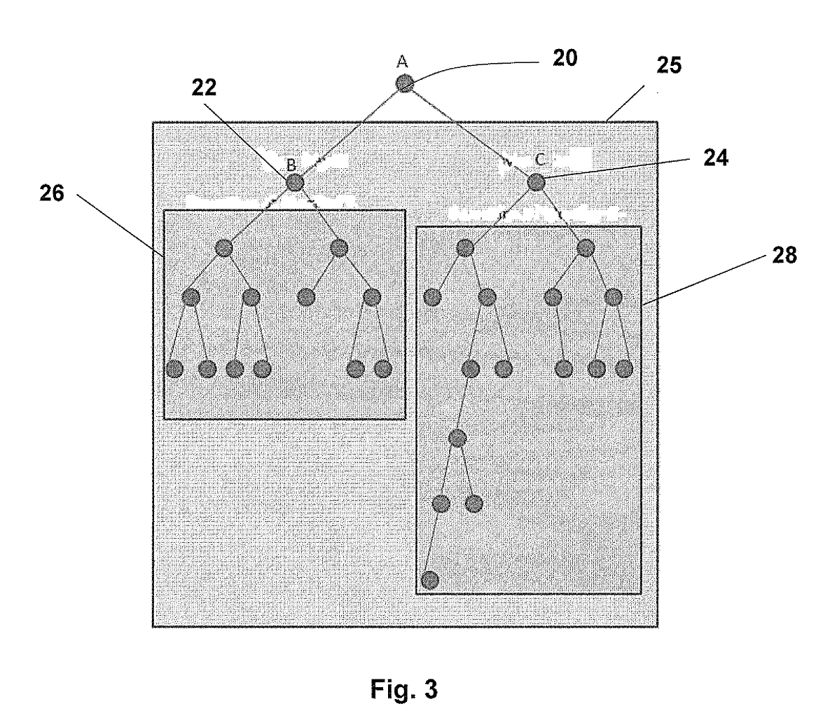

The concept of down-line is clarified in FIG. 3 which shows an example of an hierarchy of MLM network club members in accordance to their recruiting order. Recruiting down-lines of three members 20(A), 22(B) and 24(C) are shown in FIG. 3. Member 20 recruited Member 22 and member 24. All the members in rectangle 25 are in the down-line of member 20. Similarly, all the members in rectangle 26 are in the down-line of member 22, and all the members in rectangle 28 are in the down-line of member 24. Thus member 20 may enjoy from purchases done by both down-lines 25 and 26. Thus, such a compensation method enhances a recruiter to recruit other members and guide them to further recruit other customers, as many as possible. In a preferred embodiment, the club offers the members a recruiting seminar to improve their knowledge of the club affairs and enhance their marketing capabilities. For club members who successfully devote part of their time to recruiting activities for the club, the club membership may be quite a significant income source.

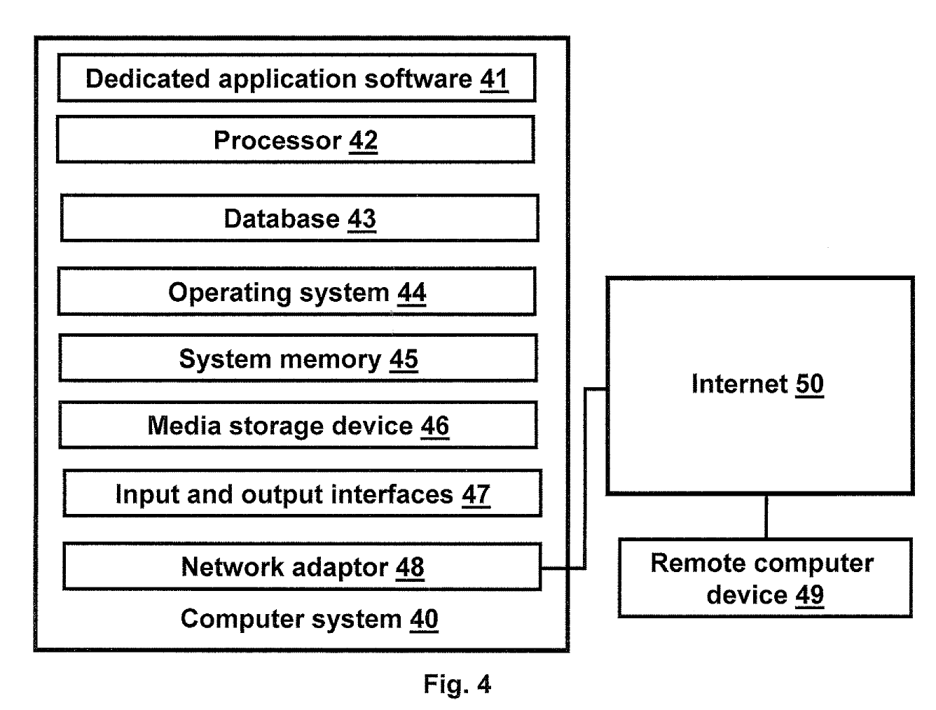

Referring now to FIG. 4, club 11 is using a computer system 40 to follow the financial and membership activities. Commission calculations, for example, are conducted by a dedicated application software 41 which is running on a processor 42 and stored in a data base 43 of which is operated by the club.

Computer system 40 may include but is not limited to known systems such as server computers, personal computers, laptops, notebooks and multiprocessor devices.

Computer system 40 may further include but is not limited to: an operating system 44 a system memory 45 a media storage device 46 and an input and output interfaces 47 such as a keyboard, a pointing device and a display.

The computer system of the club may also include a network adapter 48 enabling it to operate in a computer network environment and to be connected to remote computer devices 49 possessed by club-member 12 and participating businesses 14 via the internet 50.

While the invention has been described with respect to a limited number of embodiments, it will be appreciated that many variations, modifications and other applications of the invention may be made without departing from the spirit and scope of the invention.

What is claimed is:

1. A multilevel marketing network system for businesses and consumers comprising of:
(a) a club which arranges membership of the consumers and participation of businesses in the multilevel marketing network and coordinates the multilevel marketing network operation,
(b) at least one participant business which provides goods or services,
(c) a plurality of club members in said club which includes at least a single club member which purchases in said at least one participant business, said plurality of club members in said club are organized in a recruiting down-line hierarchy,
wherein said at least one participant business offers a discount to said plurality of club members and each club member among said plurality of club members is rewarded in accordance to purchases in said at least one participant business of club members placed on the recruiting down-line of said each club member.

2. The system as in claim 1 wherein said club sells club money to said at least single club member.

3. The system as in claim 2 wherein nominal value of said club money is no less than buying price of said club money.

4. The system as in claim 2 wherein revenues of said club include redemption of selling said club money.

5. The system as in claim 1 wherein a club member among the said plurality of club members recruits a consumer to become an additional club member.

6. The system as in claim 1 wherein a club member among the said plurality of club members persuades a business to become a participant business in the multilevel marketing network.

7. The system as in claim 2 wherein said at least one participant business commits to accept club money as a partial payment for its goods or services.

8. The system as in claim 7 herein said at least single club member among said plurality of club members pays with club money said partial payment.

9. The system as in claim 8 wherein said discount offered by said at least one participant business to said plurality of club members is implemented by said partial payment with said club money.

10. The system as in claim 2 wherein said club sells club money to a non-club member consumer

11. The system as in claim 2 wherein a club member among said plurality of club members sells club money to a non-club member consumer.

12. The system as in claim 1 wherein said club pays a reward to each club member among said plurality of club members in accordance to total actual sales in the multilevel marketing network which were effected by said each club member.

13. The system as in claim 12 wherein said reward includes a monetary reward.

14. The system as in claim 13 wherein said monetary reward is for a payment selected from the group consisting of a payment for buying club money, a payment for persuading new business to join the multilevel marketing system and a recruiting commission.

15. The system as in claim 14 wherein said recruiting commission includes a monthly payment to said each club member in accordance to the monthly total amount of said club money which was purchased by club members in said recruiting down-line of said each member.

16. The system as in claim 13 wherein allocation of said monetary reward to said at least single club member is implemented by using an application software running on a processing unit of a computer system.

17. The system as in claim 16 wherein said computer system further includes: an operating system, a system memory, a media storage device, input and output interfaces and an internet network adaptor.

18. A method for multilevel marketing network which combines consumers and businesses, comprising the steps of:
(a) establishing a multilevel marketing network which includes;
i a club which arranges membership of consumers and participation of businesses in the multilevel marketing network,
ii at least one participant business in said multilevel marketing network which offers discount to members of said club,
iii a plurality of club members in said club which include at least a single club member which purchases in said at least one participant business, said plurality of club members are organized in a recruiting down-line hierarchy,
(b) advertising said at least one participant business in a page of a website of said club,
(c) buying club money by said at least single club member from said club,
(d) making a purchase by said at least single club member at said at least one participant business and paying partially for said purchase with said bought club money, and
(e) recruiting by a club member among said plurality of club members at least one additional customer to become a new club member, wherein said new club member belongs to said recruiter down-line headed by the recruiting club member.

19. The method as in claim 18 wherein advertising of at least one participant business in a page of a website of said club is free.

20. The method as in claim 18 further including the step of persuading by a club member among said plurality of club members at least one additional business to join the multilevel marketing network.

21. The method as in claim 18 wherein nominal value of said club money is no less than buying price of said club money.

22. The method as in claim 18 wherein said at least one participant business commits to accept club money as a partial payment for its goods or services.

23. The method as in claim 22 wherein said partial payment with said club money implements said discount offered by said at least one participant business to said plurality of club members.

24. The method as in claim 23 wherein said advertising includes an announcement of said discount offered by said at least one participant business to said plurality of club members

25. The method as in claim 18 further including the steps of:
(g) paying a reward to each club member among said plurality of club members by said club in accordance to total actual sales in the multilevel marketing network which were effected by said each club member,
(h) rewarding said club member persuader of said at least one additional business by said club, and
(i) selling club money to non club members.

26. The method as in claim 25 wherein the paying a reward includes paying a monetary reward.

27. The system as in claim 26 wherein the paying of monetary reward is selected from the group consisting of payment for said buying of club money, payment for said persuading of additional business to join the multilevel marketing network and payment for member recruiting commission.

28. The system as in claim 27 wherein said recruiting commission includes a periodical payment to said each member in accordance to the periodical total amount of club money which was purchased by said recruiting down line of said each member.

29. The method as in claim 25 wherein said selling of said club money to a non-club member is carried out by said club.

30. The method as in claim 25 wherein said selling of said club money to a non-club member is carried out by a club member.

31. The method as in claim 27 wherein said allocation of said monetary reward is implemented by using an application software running on a processing unit of a computer system.

32. The method as in claim 25 wherein said rewarding said club member persuader of said at least one additional business is in accordance with one of a group consisting of all sales of the business to all club members, the size of the business in terms of annual revenues, and the number of stores of the business.
